(19) United States
(12) Patent Application Publication
(10) Pub. No.: US 2017/0373312 A1
(43) Pub. Date: Dec. 28, 2017

(54) ELECTRODE COMPOSITIONS COMPRISING CARBON ADDITIVES

(71) Applicant: Cabot Corporation, Boston, MA (US)

(72) Inventors: Paolina Atanassova, Waltham, MA (US); Aurelien L. DuPasquier, Westford, MA (US); Miodrag Oljaca, Concord, MA (US)

(21) Appl. No.: 15/437,707

(22) Filed: Feb. 21, 2017

Related U.S. Application Data
(63) Continuation of application No. 14/716,123, filed on May 19, 2015, now abandoned.
(60) Provisional application No. 62/009,973, filed on Jun. 10, 2014.

(51) Int. Cl. H01M 4/57; H01M 4/04; H01M 4/62; H01M 10/06

(52) U.S. Cl. CPC H01M 4/57; H01M 4/627; H01M 4/0404; H01M 4/625; H01M 10/06

(57) ABSTRACT

Disclosed herein are electrode compositions comprising a homogeneous mixture comprising: a lead-containing material and a carbon additive comprising carbon black and activated carbon. A total amount of the carbon additive ranges from 0.1% to 2% by weight, relative to the total weight of the composition. The composition can have a ratio of carbon black to activated carbon ranging from 0.1:0.9 to 0.5:0.5. The activated carbon can have a d₅₀ particle size distribution ranging from 4 μm to 100 μm, and a pore volume of at least 0.7 cm³/g. Also disclosed are electrodes formed from the electrode composition, cells (e.g., lead-acid battery) comprising the electrodes/electrode compositions, and methods of making thereof.

### CROSS REFERENCE TO RELATED APPLICATION

This application claims priority under 35 U.S.C. §119(e) to U.S. Provisional Application No. 62/009,973, filed on Jun. 10, 2014, the disclosure of which is incorporated herein by reference

### FIELD OF THE INVENTION

Disclosed herein are electrode compositions comprising a lead-containing material and a carbon additive comprising carbon black and activated carbon. The compositions can be incorporated into electrode materials for use in, e.g., lead acid batteries.

### BACKGROUND

A variety of applications such as micro-hybrid cars and energy storage require lead acid batteries to operate continuously at Partial State of Charge (PSoC) conditions. Moreover, in contrast to conventional battery applications, hybrid vehicles have high power requirements during ignition, braking, cabin-heating, etc., requiring faster recharge rates of the battery. Future applications may operate at different cycling conditions and charge rates, including motive power and stationary flooded batteries where both increased cycle-life and faster charging capability are desired. Accordingly, there remains a need to develop new electrode materials to meet the ever-increasing battery requirements.

### SUMMARY

One embodiment provides an electrode composition comprising a homogeneous mixture comprising:

a lead-containing material and a carbon additive comprising carbon black and activated carbon,

wherein:

a total amount of the carbon additive ranges from 0.1% to 2% by weight, relative to the total weight of the composition,

a ratio of carbon black to activated carbon ranges from 0.1:0.9 to 0.5:0.5, and

the activated carbon has a d₅₀ particle size distribution ranging from 4 μm to 100 μm, and a pore volume of at least 0.7 cm³/g.

Another embodiment provides a method of making an electrode composition, comprising:

combining a lead-containing material and a carbon additive comprising carbon black and activated carbon, to form a mixture, wherein the carbon black is pre-wetted;

adding to the mixture sulfuric acid and water to form a slurry.

### BRIEF DESCRIPTION OF THE DRAWING(S)

FIG. 1A is a bar graph showing paste density (g·cm⁻³) for pastes containing different carbon additives versus a control (no carbon additive);

FIG. 1B is a bar graph showing paste penetration (mm) for pastes containing different carbon additives versus a control (no carbon additive);

FIG. 2A is a bar graph showing phase content (wt %) of Pb and PbO for freshly formed NAM samples from anode plates containing different carbon additives versus a control (no carbon additive);

FIG. 2B shows XRD spectra of freshly formed NAM samples from anode plates, with the inset showing the PbO peak region; and

FIG. 3 is a stacked plot of end of charge (EOC, top) and end of discharge (EOD) cell voltage (V) as a function of time for cells made from anodes containing the NAM samples.

### DETAILED DESCRIPTION

It has been discovered that the addition of a carbon additive to an electroactive material (e.g., a lead-containing material) can enhance electrode performance. Without wishing to be bound by any theory, such carbon additives can improve conductivity, control lead sulfate crystallite growth, and/or enhance electron transfer processes at the electrode, where charge and discharge also occur at the carbon surface. While high surface area carbonaceous materials can improve dynamic charge acceptance (DCA) and cycle life, they can deleteriously reduce the cold crank ability and/or increase water loss on overcharge.

Certain electrode compositions containing activated carbon have shown increased porosity due at least in part to their larger particle size. However, activated carbon does not impart conductivity properties to the same extent as carbon black and requires higher loadings to obtain a performance benefit.

Disclosed herein are electrode compositions comprising a homogeneous mixture comprising a carbon additive comprising carbon black and activated carbon. Electrodes made from these compositions can be used in lead-acid batteries.

One embodiment provides an electrode composition comprising a homogeneous mixture comprising:

lead-containing material and a carbon additive comprising carbon black and activated carbon, wherein:

a total amount of the carbon additive ranges from 0.1% to 2% by weight, relative to the total weight of the composition,

a ratio of carbon black to activated carbon ranges from 0.1:0.9 to 0.5:0.5, and

the activated carbon has a d₅₀ particle size distribution ranging from 4 μm to 100 μm, and a pore volume of at least 0.7 cm³/g.

During charging of a conventional lead acid battery, PbSO₄ crystallites dissolve to release Pb²⁺ ions that undergo electron transfer reactions with the metal surface and form Pb. The opposite occurs during discharge, where Pb is converted back to Pb²⁺, followed by crystallization of PbSO₄, which can dissolve to provide a source of Pb²⁺ ions for another charging cycle. Under continuous PSoC conditions, the charging cycle occurs at very high rates such that the electron transfer processes occur at the outer surface of the plates, resulting in buildup of lead sulfate. Because the battery is never fully charged, this results in a reduced amount of lead sulfate that is converted back to lead and large lead sulfate crystals are formed. Such accumulation of lead sulfate can diminish battery performance and ultimately lead to battery failure.

Without wishing to be bound by any theory, it is believed that both carbon black and activated carbon can increase the surface area of the electrode composition (e.g., a negative active material, NAM). However, carbon blacks due to their small particle size can act as a seed layer for lead crystallites growth and lead to reduction of NAM pore size and thus a higher “energetic” lead structure, which facilitates dynamic charge acceptance. In contrast, activated carbon due to its large particle size has less strong effect on NAM porosity, and can be well connected in the “skeleton” of the NAM. While carbon additives in general can increase pore volume, the larger size of activated carbon compared to other additives such as carbon black can enhance this effect. Moreover, the active carbon can provide a 3-D framework where its larger size can provide a larger contact area for the lead sulfate crystallites, preventing excessive accumulation within the plate. Finally, the larger pore volume can also provide higher H₂SO₄ concentration within the electrode, allowing the supply of H⁺ and HSO₄⁻ when needed. Electron transfer reactions resulting in PbSO₄ formation can occur over a greater surface area with the 3D network afforded by the activated carbon.

One embodiment provides an electrode composition in which at least the lead-containing material and carbon additive are uniformly interspersed with each other. Thus, none of the components of the homogeneous mixture are provided as layers or coatings. In one embodiment, other components of the electrode composition (e.g., BaSO₄, H₂SO₄) are uniformly interspersed with the lead-containing material and carbon additive.

Without wishing to be bound by any theory, it is believed that a mixture of carbon black and activated carbon maximizes the contributions from both carbon types. Carbon black enhances conductivity by providing a surface for electron transfer reactions, and can modify the morphology of the plate, resulting in the formation of smaller PbSO₄ crystallites. However, the small size of carbon black can reduce pore volume of the electrode composition. With a mixture of carbon black and activated carbon, the amount of activated carbon can be reduced while providing a sufficient amount to achieve described benefits. Accordingly, one embodiment provides an equal or lesser amount of activated carbon with respect to carbon black, e.g., in a ratio ranging 0.1:0.9 to 0.5:0.5, e.g., a ratio ranging from 0.1:0.9 to 0.45:0.55, a ratio ranging from 0.1:0.9 to 0.4:0.6, or a ratio ranging from 0.1:0.9 to 0.35:0.65.

In one embodiment, the total amount of the carbon black and activated carbon ranges from 0.1% to 1.9% by weight, relative to the total weight of the composition, e.g., a total amount ranging from 0.1% to 1.8% by weight, from 0.1% to 1.7% by weight, from 0.1% to 1.6% by weight, from 0.1% to 1.5% by weight, from 0.1% to 1.4% by weight, from 0.1% to 1.3% by weight, from 0.1% to 1.2% by weight, from 0.1% to 1.1% by weight, or from 0.1% to 1% by weight, relative to the total weight of the composition.

In one embodiment, the carbon black is present in an amount ranging from 0.1% to 1% by weight, relative to the total weight of the composition, e.g., an amount ranging from 0.1% to 0.9% by weight, from 0.1% to 0.8% by weight, from 0.1% to 0.7% by weight, from 0.1% to 0.6% by weight, from 0.1% to 0.5% by weight, from 0.1% to 0.4% by weight, from 0.1% to 0.3% by weight, from 0.2% to 1% by weight, from 0.2% to 0.9% by weight, from 0.2% to 0.8% by weight, from 0.2% to 0.7% by weight, from 0.2% to 0.6% by weight, from 0.2% to 0.5% by weight, from 0.2% to 0.4% by weight, or from 0.2% to 0.3% by weight, relative to the total weight of the composition.

In one embodiment, the activated carbon is present in an amount ranging from 0.1% to 1% by weight, relative to the total weight of the composition, e.g., an amount ranging from 0.1% to 0.9% by weight, from 0.1% to 0.8% by weight, from 0.1% to 0.7% by weight, from 0.2% to 1% by weight, from 0.2% to 0.9% by weight, from 0.2% to 0.8% by weight, from 0.2% to 0.7% by weight, from 0.3% to 1% by weight, from 0.3% to 0.9% by weight, from 0.3% to 0.8% by weight, from 0.3% to 0.7% by weight, from 0.4% to 1% by weight, from 0.4% to 0.9% by weight, from 0.4% to 0.8% by weight, from 0.4% to 0.7% by weight, from 0.5% to 1% by weight, from 0.5% to 0.9% by weight, from 0.5% to 0.8% by weight, or from 0.5% to 0.7% by weight, relative to the total weight of the composition.

In one embodiment, the activated carbon is particulate, e.g., the activated carbon has an aspect ratio (length/diameter) of e.g., 10 or less, 5 or less, or 3 or less. In one embodiment, the activated carbon has a d₅₀ particle size distribution ranging from 4 μm to 50 μm, e.g., a d₅₀ particle size distribution ranging from 4 μm to 20 μm, or from 4 μm to 10 μm.

In one embodiment, the activated carbon itself has a pore volume of at least 1 cm²/g, e.g., at least 1.5 cm²/g. Activated carbon and high surface area carbon blacks can act as a super capacitor due to double layer formation on its micro porous surface. Supercapacitive effect is proportional to the nitrogen adsorption surface area and could contribute to improved charge acceptance at short time duration (few seconds).

In one embodiment, the activated carbon has a surface area ranging from 650 m²/g to 3000 m²/g, e.g., from 650 m²/g to 2500 m²/g, from 650 m²/g to 2000 m²/g, from 1000 m²/g to 3000 m²/g, from 1000 m²/g to 2500 m²/g, from 1000 m²/g to 2000 m²/g, from 1200 m²/g to 3000 m²/g, from 1200 m²/g to 2500 m²/g, or from 1200 m²/g to 3000 m²/g.

In one embodiment, the activated carbon is obtained by carbonizing/activating a raw material selected from peat, wood, lignocellulosic materials, biomass, waste, tire, olive pits, peach pits, corn hulls, rice hulls, petroleum coke, lignite, brown coal, anthracite coal, bituminous coal, sub-bituminous coal, coconut shells, pecan shells, and walnut shells, and other raw materials known in the art. In one embodiment, the activated carbons disclosed herein are lignite-based activated carbons or bituminous coal-based activated carbons (e.g., derived from lignite or bituminous coal).

In one embodiment, the carbon black has a surface area ranging from 50 m²/g to 2000 m²/g, e.g., from 100 m²/g to 1500 m²/g. In another embodiment the carbon black has a surface area ranging from 100 m²/g to 500 m²/g, e.g., from 100 m²/g to 400 m²/g, or from 100 m²/g to 300 m²/g.

In one embodiment, the carbon black has a surface area ranging from 100 m²/g to 300 m²/g and the activated carbon has a surface area ranging from 650 m²/g to 2000 m²/g, e.g., from 1000 m²/g to 2000 m²/g or from 1200 m²/g to 2000 m²/g.

In one embodiment, the carbon black has a pore volume of at least 0.2 g/cm³, e.g., a pore volume ranging from 0.2 g/cm³ to 2 g/cm³.

In one embodiment, the homogeneous mixture further comprises an organic molecule expander. “Organic molecule expander” as defined herein is a molecule capable of adsorbing or covalently bonding to the surface of a lead-containing species to form a porous network that prevents or substantially decreases the rate of formation of a smooth layer of PbSO₄ at the surface of the lead-containing species. In one embodiment, the organic molecule expander has a molecular weight greater than 300 g/mol. Exemplary organic molecule expanders include lignosulfonates, lignins, wood flour, pulp, humic acid, and wood products, and derivatives or decomposition products thereof. In one embodiment, the expander is selected from lignosulfonates, a molecule having a substantial portion that contains a lignin structure. Lignins are polymeric species comprising primarily phenyl propane groups with some number of methoxy, phenolic, sulfur (organic and inorganic), and carboxylic acid groups. Typically, lignosulfonates are lignin molecules that have been sulfonated. Typical lignosulfonates include the Borregard Lignotech products UP-393, UP-413, UP-414, UP-416, UP-417, M, D, VS-A (Vanisperse A), Vanisperse-HT, and the like. Other useful exemplary lignosulfonates are listed in, “Lead Acid Batteries”, Pavlov, Elsevier Publishing, 2011, the disclosure of which is incorporated herein by reference.

In one embodiment, the organic molecule expander is present in an amount ranging from 0.05% to 1.5% by weight, e.g., from 0.2% to 1.5% by weight, or from 0.3% to 1.5% by weight, relative to the total weight of the electrode composition.

In one embodiment, the lead-containing material is selected from lead, PbO, leady oxide, Pb₃O₄, Pb₂O, and PbSO₄, hydroxides, acids, and metal complexes thereof (e.g., lead hydroxides and lead acid complexes). In one embodiment, lead-containing material comprises leady oxide. In another embodiment, the homogeneous mixture further comprises BaSO₄.

In one embodiment, the electrode composition is an aqueous slurry. In another embodiment, the homogeneous mixture is a porous solid. For example, curing the aqueous slurry can form the porous solid. In one embodiment, the porous solid and has a surface area of at least 4 m²/g, e.g., at least 5 m²/g.

Another embodiment comprises an electrode comprising the compositions disclosed herein (e.g., a solid homogeneous mixture disclosed herein). The electrode can be an anode and can be incorporated into a lead acid battery.

Another embodiment provides a method of making a composition, comprising:

combining a lead-containing material and a carbon additive comprising carbon black and activated carbon, to form a mixture, wherein the carbon black is pre-wetted;

adding to the mixture sulfuric acid and water to form a slurry.

In one embodiment, the composition is an electrode composition. In one embodiment, the carbon additive is present in an amount ranging from 0.1% to 2% by weight, relative to the total weight of the composition.

In one embodiment, the slurry (e.g., a paste) is dried. In one embodiment, the drying is achieved by a slow cure, such as under controlled humidity conditions and a moderate amount of heat (e.g., from 30 to 80° C. or from 35 to 60° C.) under controlled humidity, resulting in a porous solid. The curing step can then followed by a second heating step (drying) at an elevated temperature (e.g., from 50 to 140° C. or from 65 to 95° C.) at extremely low humidity, or even zero humidity. In one embodiment, the composition is a monolith. Other pasting, curing, and formation procedures are described in “Lead Acid Batteries,” Pavlov, Elsevier Publishing, 2011, the disclosure of which is incorporated herein by reference.

In one embodiment, the slurry (e.g., a paste) is deposited (or otherwise pasted) onto a substrate, such as a plate or grid and allowed to dry on the substrate, where the drying can be performed as disclosed herein. In one embodiment, the plate or grid is a metallic structure that come in a myriad of designs and shapes (e.g., punched or expanded from sheets), functioning as the solid permanent support for the active material. The grid also conducts electricity or electrons to and away from the active material. Grids can comprise pure metals (e.g., Pb) or alloys thereof. The components of those alloys can comprise Sb, Sn, Ca, Ag, among other metals described in “Lead Acid Batteries,” Pavlov, Elsevier Publishing, 2011, the disclosure of which is incorporated herein by reference.

In one embodiment, the electrode is formed when the cured material that is deposited on the plate is subjected to a charging process. For example, this process can comprise immersing the cured, deposited material in a tank containing an H₂SO₄ solution and charging the material from 120% to 400% of theoretical capacity for a period of time, e.g., at least 2 h, e.g., from 2 h to 25 h.

Accordingly, disclosed herein are electrode compositions comprising a homogeneous mixture comprising an electroactive material (e.g., the lead-containing material) and a carbon additive. Initially, the mixture is in the form of a paste, e.g., a negative paste. When such a mixture is cured or formed, it is termed a negative active material (NAM). The carbon additive can comprise, consist essentially of, or consist of carbon black and activated carbon in the amounts and proportions disclosed herein. Such electrode compositions can be deposited on conducting substrates to form an electrode (e.g., an anode) that can be incorporated in a cell, e.g., a lead-acid battery.

### EXAMPLES

### Example 1

This Example describes the preparation of anode materials containing various carbon additives including carbon black alone, and mixtures of carbon black+graphite, and carbon black+activated carbon.

### Carbon Additives Tested

Commercially available carbon black (CB) additives (PBX™ 51, PBX™ 09, and PBX™ 135 additives, Cabot Corporation) were selected to study the impact of BET surface area and morphology by comparing them with an activated carbon (AC; PBX™ 101 activated carbon, Cabot Corporation), and expanded graphite (EG; ABG™ 1010 graphite, Superior Graphite). Mixtures of carbon blacks (PBX™ 135 additive) and activated carbon (PBX™ 101 activated carbon) or expanded graphite (ABG1010) were also studied. The BET specific surface areas and loadings of carbons in the negative active mass (NAM) are listed in Table 1.

TABLE 1

| | Specific | | |
|---|---|---|---|
| | surface area, | Pore Volume | Loading, |
| Carbon type | m²g⁻¹ | (cm³/g | wt. % |
| PBX51 ™ (CB) | 1400 | 1.5 | 0.5 |
| PBX101 ™ (AC) | 1400 | 0.7 | 1 |
| PBX09 ™ (CB) | 220 | 1.1 | 1 |
| PBX135 ™ (CB) | 150 | 0.5 | 0.5, 1 |
| ABG1010 ™ (EG) | 25 | 0.1 | 1 |
| 0.5% PBX135 ™ (CB) + | 150 and 25 | | 1.5 total |
| 1% ABG1010 ™ (EG) | | | |
| 0.5% PBX135 (CB) + | 150 and 1400 | | 1.5 total |
| 1% PBX101 ™ (AC) | | | |

Additionally, PBX101 AC has a d₅₀ particle size distribution of 4.5 μm.

### Anode Compositions: Preparation and Characterization

Negative pastes with different carbon materials and concentrations were produced and lead-acid cells were assembled. Pastes were produced at a 1 kg batch size using 1.40 g cm⁻³ H₂SO₄ and leady oxide (75% degree of oxidation) at a ratio equal to 6.0 wt %. The pastes were prepared by dry mixing 1 kg leady oxide (2 min) then adding 2 g Vanisperse A lignosulfonate, 8 g barium sulfate, and carbon additives and mixed for 5 min. All carbon black additives were pre-wetted prior to being added to the mixture, whereas PBX101 activated carbon and ABG1010 expanded graphite were used without pre-wetting. Water (130 mL) was added and mixed for 8 min, followed by addition of 80 mL 1.4 g/cc sulfuric acid and mixing for 20 min. Additional water was added when needed at the end of the mixing.

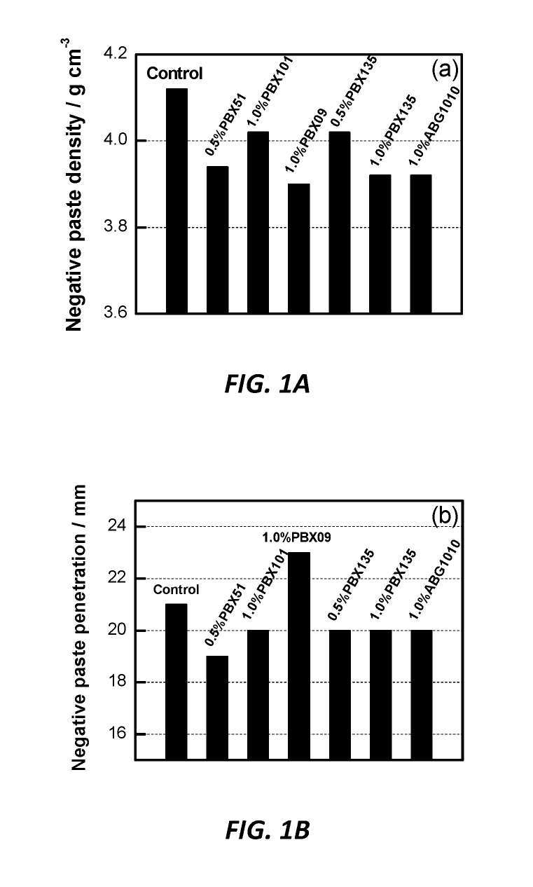

FIGS. 1A and 1B show the negative paste density (g·cm⁻³) and paste penetration (mm) as determined for the different paste samples (having different carbon additives) in comparison to a control sample with no carbon additive. Although paste density was slightly lower than the control, adjustment in water content resulted in similar consistency as evidenced by penetration depth, and resulting in good pasting ability.

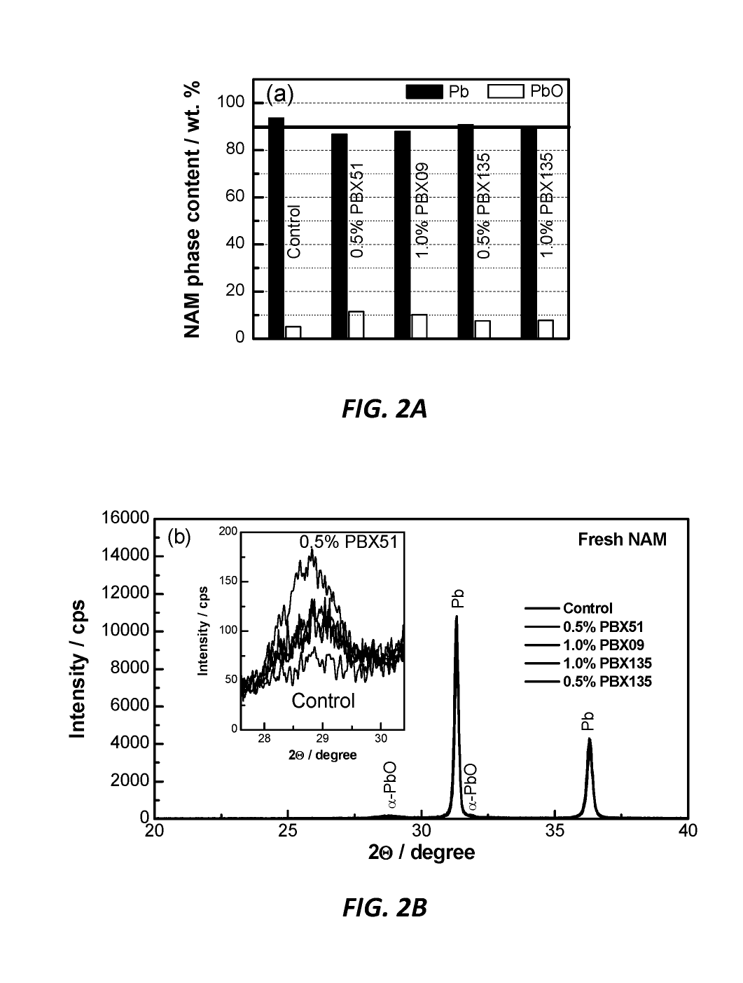

The negative plates were made of lead Pb-0.04 Ca-1.10 Sn alloy and had grid dimensions of 57 mm×60 mm×1.5 mm. The coated plates had a thickness of 2.5 mm. Curing was done for 72 hours at 35° C. and 98% relative humidity, followed by 24 hours at 60° C. and 10% relative humidity. The coated negative electrodes were formed by a tank formation process by using 1.06 g cm⁻³ H₂SO₄ solution and charging to 400% of theoretical capacity for 25 h. The formed plates were characterized by XRD and were similar to control. As shown in FIG. 2A, chemical titration of Pb and PbO in freshly formed NAM plates indicated similar levels (wt %) of Pb but higher amounts of PbO than in control (up to 10% vs. 5% for control). FIG. 2B shows XRD spectra of the NAM samples, with the inset showing the PbO peaks. The PBX51-containing sample provided the highest PbO peak in the XRD whereas the lowest PbO peak arose from the control. Without wishing to be bound by any theory, the increased levels of PbO may be related to the formation of smaller lead crystallites and consecutively to higher surface area of lead exposed to air and moisture causing higher degree of oxidation upon exposure to ambient conditions.

NAM surface areas were measured by BET nitrogen adsorption, and NAM pore area, pore size volume and pore size were measured by mercury porosimetry (Micromeritics Instrument Corporation) (Table 2). A reduction of median pore radius is observed with carbon black additives, the smallest pore size was observed for the carbon black with highest surface area (PBX51), which can be related to the smaller primary and aggregates size compared to lower surface carbon blacks like PBX09 and PBX135. The formation of PbO due to oxidation can also contribute to reduction in pore radius over time. For same BET area, activated carbon PBX101 causes less pore radius reduction. In contrast, expanded graphite additive creates larger pore radius than the control.

TABLE 2

| | Carbon | NAM | NAM | NAM | NAM |
|---|---|---|---|---|---|
| | BET | BET | Total | Total | Median |
| | Surface | Surface | pore | pore | pore |
| | area | area | area | volume | radius |
| Carbon sample | [m²/g] | [m²/g] | [m²/g] | cm³/g | [μm] |
| Control | NA | 0.52 | 0.72 | 0.1418 | 2.35 |
| 0.5% PBX51 | 1400 | 4.07 | 1.85 | 0.1977 | 1.30 |
| 1.0% PBX101 | 1400 | 10.5 | 0.80 | 0.1378 | 1.88 |
| 1.0% PBX09 | 220 | 1.41 | 1.35 | 0.1305 | 1.52 |
| 0.5% PBX135 | 150 | 0.86 | 1.11 | 0.1448 | 1.57 |
| 1.0% PBX135 | 150 | 1.24 | 1.28 | 0.1344 | 1.77 |
| 1.0% ABG1010 | 25 | 0.62 | 0.85 | 0.1450 | 3.15 |
| 0.5% PBX135 + | | 1.22 | 1.12 | 0.1364 | 1.82 |
| 1% ABG1010 | | | | | |
| 0.5% PBX135 + | | 7.52 | 1.12 | 0.1515 | 2.51 |
| 1% PBX101 | | | | | |

### Example 2

This Example describes testing on cells containing the anodes of Example 1.

Single cells (2V, 4.8 Ah nominal capacity) were assembled with 2 negative and 3 positive plates, in flooded configurations and filled with 1.28 g/cc sulfuric acid. The cells were subjected to an accelerated cycling test according the following procedure: discharge with C/10 A current from 100% to 80% SoC; discharge with current C/2 A down to 30% SoC and recharge with C/2 A to 80% SoC; after 6^{th} discharge cycle a charge with C/10 for 12 h was conducted. The above described cycling schedule comprised one cycling unit of the accelerated cycling test. The total time duration of one cycling unit was 32 h. The cell voltage was measured during the cycling, and the test was stopped when the end-of-discharge cell voltage fell below 1.70 V.

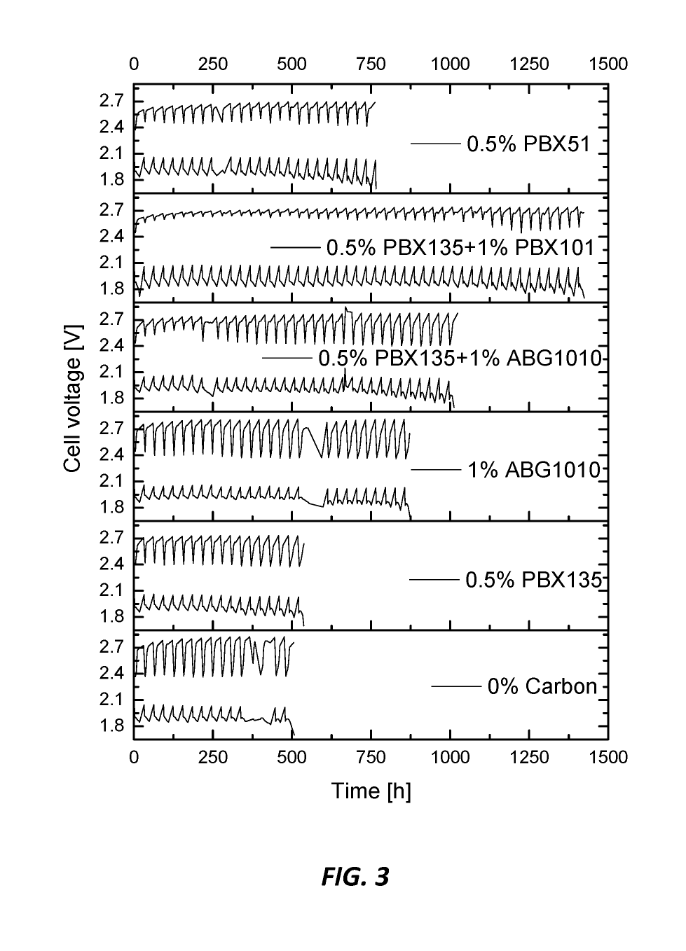

FIG. 3 is a stacked plot of end of charge (EOC, top) and end of discharge (EOD) cell voltage (V) as a function of time for cells made from anodes containing the NAM samples, indicating the cell cycle life. The recorded values of end-of-discharge and end-of-charge voltages at each cycle for cells with different NAM formulations compared to the control cell, containing the anode without carbon additive. The cell cycle life of the control cell was 16 units. Intermediate surface area carbon blacks like PBX09 (0.5%) and PBX135 (0.5% and 1%) did not lead to significant improvement in cycle life, reaching 18 units. In contrast, high surface area PBX51 (0.5%) cell cycle life was 25 units, or ^{˜}50% improvement. Expanded graphite ABG1010 (1%) showed similar cycle life of 28 units. Even higher cycle life was achieved for a cells with mixture of carbon black PBX135 (0.5%) and ABG1010 (1%), which at 36 units was more than a 2× improvement compared to the control. The highest cycle life (47 units) was observed for the cell with the mixture of PBX135 (0.5%) and PBX101 (1%), or approximately 3× improvement versus the control.

It can be seen that the use of carbon additives in the negative plates leads to a modification of negative plate morphology and affects the average pore diameter. Carbon black additive with highest surface area (PBX51) has the strongest impact on the NAM morphology, charge acceptance and cycle life compared to intermediate surface area carbon blacks (PBX09, PBX135). Combinations of intermediate surface area carbon black (PBX135) and activated carbon (PBX101) leads to significant improvement of cycle life, up to 3× compared to the control, and greater than the mixture of carbon black with expanded graphite.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. An electrode composition comprising a homogeneous mixture comprising:
a lead-containing material and a carbon additive comprising carbon black and activated carbon,
wherein:
a total amount of the carbon additive ranges from 0.1% to 2% by weight, relative to the total weight of the composition,
a ratio of carbon black to activated carbon ranges from 0.1:0.9 to 0.5:0.5, and
the activated carbon has a d₅₀ particle size distribution ranging from 4 μm to 100 μm, and a pore volume of at least 0.7 cm³/g.

2. The composition of claim 1, wherein the activated carbon has a d₅₀ particle size distribution ranging from 4 μm to 20 μm.

3. (canceled)

4. The composition of claim 1, wherein the activated carbon has a pore volume of at least 1 cm²/g.

5. (canceled)

6. The composition of claim 1, wherein the total amount of the carbon additive ranges from 0.1% to 1.5% by weight, relative to the total weight of the composition.

7. (canceled)

8. The composition of claim 1, wherein the activated carbon is present in an amount ranging from 0.1% to 0.9% by weight, relative to the total weight of the composition.

9. The composition of claim 1, wherein the carbon black is present in an amount ranging from 0.1% to 0.5% by weight, relative to the total weight of the composition.

10. The composition of claim 1, wherein the activated carbon has a surface area ranging from 650 m²/g to 3000 m²/g.

11. (canceled)

12. The composition of claim 1, wherein the carbon black has a surface area ranging from 50 m²/g to 2000 m²/g.

13. (canceled)

14. The composition of claim 1, wherein the carbon black has a surface area ranging from 100 m²/g to 300 m²/g and the activated carbon has a surface area ranging from 1200 m²/g to 2000 m²/g.

15. The composition of claim 1, wherein the carbon black has a pore volume of at least 0.2 g/cm³.

16. (canceled)

17. The composition of claim 1, wherein the homogeneous mixture further comprises an organic molecule expander.

18. (canceled)

19. (canceled)

20. (canceled)

21. The composition of claim 1, wherein the homogeneous mixture further comprises BaSO₄.

22. The composition of claim 1, wherein the homogeneous mixture is an aqueous slurry.

23. The composition of claim 1, wherein the homogeneous mixture is a solid.

24. (canceled)

25. An electrode comprising the composition of claim 1.

26. A lead acid battery comprising the electrode of claim 25.

27. A method of making an electrode composition, comprising:
combining a lead-containing material and a carbon additive comprising carbon black and activated carbon, to form a mixture, wherein the carbon black is pre-wetted;
adding to the mixture sulfuric acid and water to form a slurry.

28. The method of claim 27, further comprising drying the slurry.

29. The method of claim 28, wherein the drying occurs after depositing the slurry onto a substrate to form a cured composition.

30. The method of claim 29, further comprising subjecting the cured composition to a charging process.

31. The method of claim 30, wherein the charging process comprises charging the material from 120% to 400% of theoretical capacity for at least 2 h.
